(19) United States
(12) Patent Application Publication
(10) Pub. No.: US 2009/0056643 A1
(43) Pub. Date: Mar. 5, 2009

(54) PERSONALIZED IDENTIFICATION TAG COLLAR KIT

(76) Inventors: Kristin Kimberly Hetzel, Charlotte, NC (US); Michelle Andrea Wallace, Charlotte, NC (US)

Correspondence Address: ASHLEY LAW FIRM P.C., 3440 TORINGDON WAY, SUITE 205, CHARLOTTE, NC, 28277, US

(21) Appl. No.: 12/199,154

(22) Filed: Aug. 27, 2008

Related U.S. Application Data
(60) Provisional application No. 60/979,848, filed on Oct. 14, 2007.
(60) Provisional application No. 60/968,359, filed on Aug. 28, 2007.

(51) Int. Cl. A01K 27/00

(52) U.S. Cl. 119/858

(57) ABSTRACT

A personalized identification tag collar kit, which can be used with a toy pet, can include a collar for being worn on the toy pet, a tag for being attached to the collar, and a labeling device for applying at least one personalized identifier on the tag. The collar, tag and labeling device can be contained within a transparent sealable package. The kit can include instructions that instruct the user to use the labeling device to apply a personalized identifier, such as a name for the pet or the user's own artwork, on the tag. The kit can be used with a toy pet having an alphanumeric identification code for use on an Internet website relating to the toy pet, and the labeling device can be used to apply a personalized identifier such as the identification code to the tag.

### CROSS REFERENCE TO RELATED APPLICATIONS

This application claims priority to U.S. Provisional Patent Application No. 60/968,359, filed Aug. 28, 2007, and U.S. Provisional Patent Application No. 60/979,848, filed Oct. 14, 2007, which are incorporated herein by reference.

### TECHNICAL FIELD AND BACKGROUND OF THE INVENTION

The present invention relates to an identification kit that can be used with toy pets. One embodiment of the invention comprises a collar, a tag and a labeling device which the user can use to apply a personalized identifier on the tag. The user can write a personal Internet code that comes with the toy pet, their own name and/or a name for the pet somewhere on the tag. It can also be used strictly as a fashion accessory for the stuffed animal.

Many people enjoy collecting toy pets such as stuffed animals. Stuffed animals are popular with both children and adults. Because of the popularity of recent trends such as the toy pets sold under the marks BEANIE BABIES® and WEBKINZ®, there are many people who have the same stuffed animals as their friends and/or siblings. It is often difficult to distinguish the different stuffed animals and identify them from one another. This becomes particularly problematic when children play with their similar stuffed animals together.

In addition, it has recently become popular for toy pets, such as the WEBKINZ® pets, to be sold with an alphanumeric identification code that is unique to the particular toy pet being purchased. The purchaser of the pet can use the identification code on an Internet website relating to the toy pet. By entering the identification code at the appropriate place on the website, the toy pet can be “brought to life” on the website and the purchaser of the toy pet can engage in a number of activities on the website, thus enhancing the purchaser's overall enjoyment of the toy pet.

As one may expect with a product that is used by young children, it is common for the Internet identification codes for these toy pets to become lost. Generally, it is time consuming and costly, if not impossible, to recover the lost codes. This can be particularly disappointing for a child who has spent a substantial amount of time engaged in the “virtual” Internet world of his or her particular pet, only to be unable to return when the code is lost.

### SUMMARY OF THE INVENTION

Therefore, one object of the present invention is to provide a kit for identifying toy pets so that they can be distinguished from similar toy pets. Another object of the invention is to provide a method for using an identification kit with toy pets that have an identification code for using on an Internet website relating to the toy pet. Yet another object of the invention is to provide a decorative accessory for a toy pet.

These objects of the invention can be achieved in the various embodiments of the invention described below. One embodiment of the invention is an identification tag collar kit for use with a toy pet comprising a collar for being worn on the toy pet, a tag for being attached to the collar, and a labeling device for applying at least one personalized identifier on the tag.

According to another embodiment of the invention, the kit includes a package that contains the collar, the tag and the labeling device.

According to another embodiment of the invention, the package is comprised of transparent plastic, and includes a re-sealable opening.

According to another embodiment of the invention, the package includes a label having a brand name printed thereon.

According to another embodiment of the invention, the tag is attached to the collar.

According to another embodiment of the invention, the collar is adapted for being worn on a stuffed animal.

According to another embodiment of the invention, the collar includes a fastening device for fastening and releasing the collar.

According to another embodiment of the invention, the length of the collar is adjustable, or can come in a variety of sizes.

According to another embodiment of the invention, there is an aperture in the tag, and a ring is positioned through the aperture and around the collar to attach the tag to the collar.

According to another embodiment of the invention, the labeling device can be a pen, marker, pencil, crayon, sticker, stamp, and/or paint.

According to another embodiment of the invention, the personalized identifier is a name for the pet, a name of the user, and/or an alphanumeric code.

According to another embodiment of the invention, the kit includes instructions that instruct or suggest to the user to apply at least one personalized identifier on the tag using the labeling device.

According to another embodiment of the invention, the kit includes packaging that contains the collar, the tag, the labeling device and the instructions.

According to another embodiment of the invention, the labeling device is a writing instrument, such as a pen, marker, pencil, and/or crayon, and there are instructions that instruct the user to write an alphanumeric identification code provided by the seller of the toy animal for using on an Internet website relating to the toy pet.

According to another embodiment of the invention, an identification tag collar kit for use with a toy pet comprises a collar adapted for being worn on a toy pet having an alphanumeric identification code for use on an Internet website relating to the toy pet, a tag attached to the collar, a writing instrument, and a package. The collar, tag and writing instrument are contained within the package, and there are instructions that instruct the user to use the writing instrument to write the identification code of the toy pet on the tag.

A method of using an identification tag collar kit according to an embodiment of the invention includes the steps of providing a toy pet and an identification tag collar kit comprising a collar, a tag attached to the collar, a labeling device and a package containing the collar, tag and labeling device. The collar, tag and labeling device are removed from the package, and the labeling device is used to apply a personalized identifier to the tag. The collar is positioned on the toy pet.

According to another embodiment of the invention, a stuffed animal is provided having an alphanumeric identification code for use on an Internet website relating to the toy pet, and the personalized identifier includes the identification code.

According to another embodiment of the invention, the toy pet has an alphanumeric identification code for use on an Internet website relating to the toy pet.

According to another embodiment of the invention the labeling device includes a writing instrument, and the identification code of the toy pet is written on the tag.

According to another embodiment of the invention, a name for the toy pet is written on the tag.

### BRIEF DESCRIPTION OF THE DRAWINGS

Objects of the invention have been set forth above. Further objects and advantages of the present invention may become apparent as the description of the invention proceeds when taken in conjunction with the following drawings, in which:

FIG. 1 is a perspective view of a personalized identification tag collar kit according to a preferred embodiment of the invention;

FIG. 2 is an environmental view of a personalized identification tag collar according to another embodiment of the invention, shown in use on a toy pet;

FIG. 3 is a front elevation of the personalized identification tag collar kit of FIG. 1;

FIG. 4 is a front elevation of a personalized identification tag collar according to another embodiment of the invention; and

FIG. 5 is a schematic environmental view of the identification tag collar of FIG. 4, shown in use on toy pet.

### DESCRIPTION OF THE PREFERRED EMBODIMENTS AND BEST MODE

While the present invention is described herein in detail in relation to one or more embodiments, it is to be understood that this description is illustrative and exemplary of the present invention, and is made merely for the purposes of providing a full and enabling disclosure of the present invention. The detailed description herein of various embodiments is not intended, nor is to be construed, to limit the scope of patent protection afforded the present invention, which scope is to be defined by the claims and the equivalents thereof.

Thus, for example, any sequence and/or temporal order of steps of various processes or methods that are described herein are illustrative and not restrictive. Accordingly, it is to be understood that, although steps of various processes or methods may be shown and described as being in a sequence or temporal order, the steps of any such processes or methods are not limited to being carried out in a particular sequence or order, and the steps of such processes or methods may be carried out in various different sequences and orders while still falling within the scope of the present invention.

Furthermore, it should be noted that, as used throughout the application, “a” and “an” each generally denotes “at least one,” and is not restricted to only one and does not exclude a plurality.

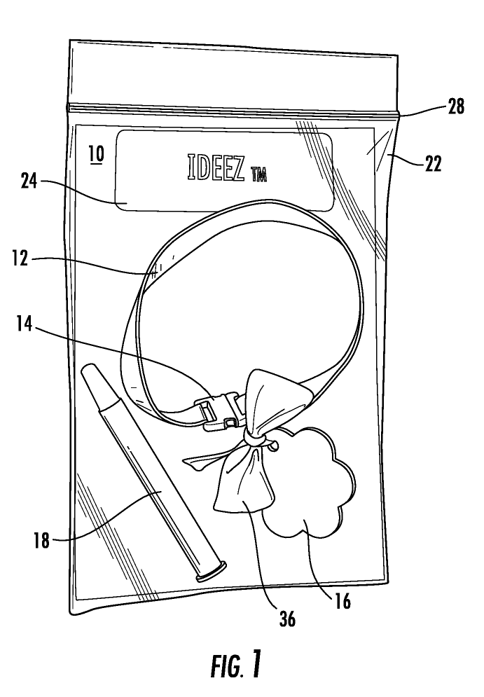

Referring now to the drawings, in which like numerals represent like components throughout the several views, a personalized identification tag collar kit according to a preferred embodiment of the invention is illustrated in FIG. 1, and shown generally at reference numeral 10. The kit 10 comprises a collar 12, an identification (“I.D.”) tag 16 attached to the collar 12, and a labeling device 18, all of which are contained within a package 22.

The labeling device 18 is preferably a marker, but can be another suitable labeling device such as a pen, pencil, crayon, sticker, stamp, or paint. Furthermore, while the kit 10 is shown having one labeling device 18, there can be multiple labeling devices, such as to provide writing instruments of varying colors.

The package 22 can be a transparent, sealable bag and can include an insert and/or labels describing the product and including a brand name. For example, the package 22 can include a label 24 with a brand name or product name printed thereon such as “IDEEZ”, as shown in FIGS. 1 and 3. Alternatively, the brand or product name can be printed directly on the package 22, or can be printed on an insert, such as a card or paper sheet, that is placed in the package 22. As shown in FIGS. 1 and 3, the collar 12, I.D. tag 16, and labeling device 18 are enclosed in the package 22. The package 22 can be made of a clear plastic, or other suitable material, and can have a re-sealable zip lock 28, as shown in FIG. 1.

The collar 12 can be made from one or more of the following materials: ribbon, trimming, fabric, leather, webbing, gimp, canvas, rubber, suede, velvet, pleather, cording, rope, elastic, jewelry beads or lacing. The collar 12 includes a fastening device 14 that allows the collar 12 to be opened and closed. The fastener 14 can be a clasp, buckle, magnets, tri-glides and/or hook and loop fastener. Alternatively, the collar can be made of a stretchable material, such that the collar can be expanded to be placed over the head of a toy pet 20, and then retracts to its original size to conform to the neck of the toy pet 20. As such, the expandable collar would not require a fastener. The length of the collar 12 can be adjustable, or alternatively the collar 12 can be offered in a variety of predetermined sizes, such as small, medium and large.

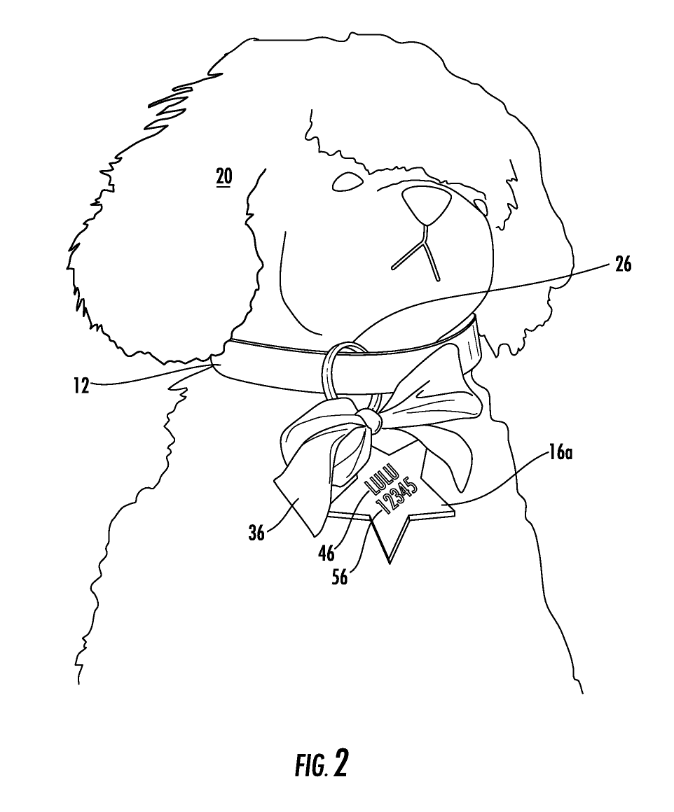

The I.D. tag 16 can be attached to the collar 12 by a ring 26 extending through an aperture in the tag 16, as shown in FIG. 2. Alternatively, the tag 16 can be a bendable member that conforms to the contour of the collar 12 and is attached directly to the collar 12, thereby eliminating the need for the ring 26.

The tag 16 can be made from any suitable material, such as wood, metal, plastic, cardboard, ceramic, porcelain, glass and/or paper. The tag 16 may be prepainted or the user may be given the option to paint it themselves.

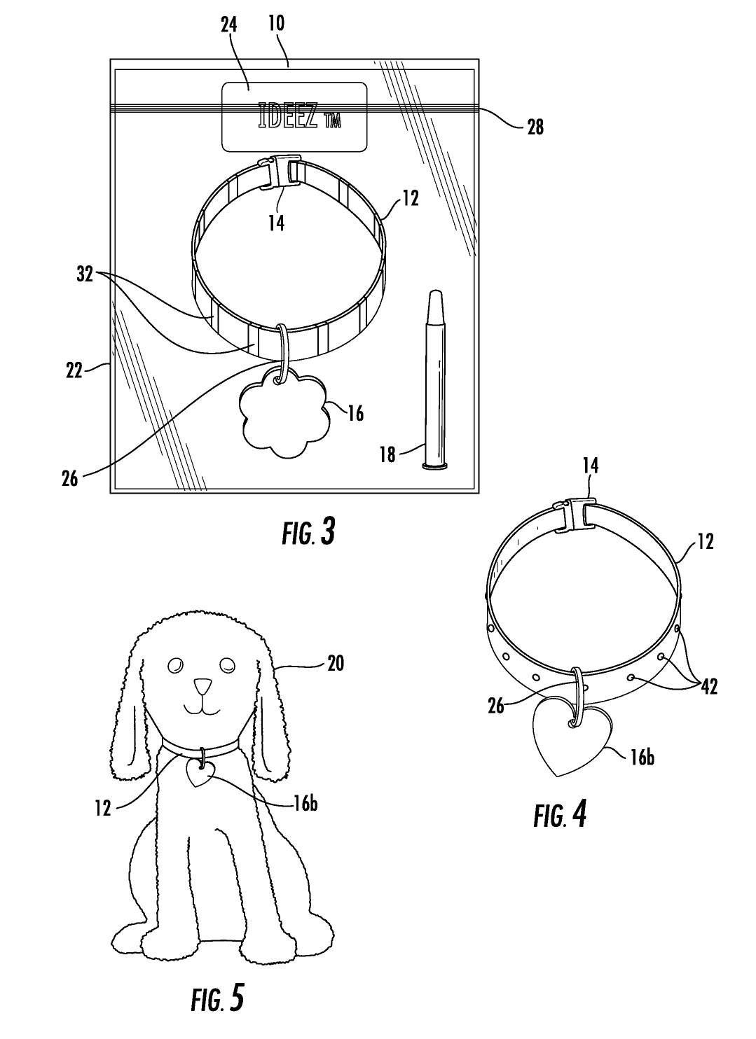

The tag 16 can be made of plastic, and can include an insert in which the user may install a picture or paper. The tag 16 can also be laminated. The tag 16 is shown in FIGS. 1 and 3 as having the general shape of a flower, however, the tag 16 can be any variety of shapes. For example, it can have the shape of star as shown in FIG. 2 at reference numeral 16a, or the shape of a heart as shown in FIGS. 4 and 5 at reference numeral 16b. Other possible shapes include, but are not limited to, a raindrop, oval, square, triangle, circle, or diamond. The tag 16 may be marked with a brand name and/or other trademark such as “Created by Frendz, LLC” and/or “IDEEZ”.

The labeling device 18 can be a pen for decorating the tag 16. The color or colors of the pen 18 may be selected to coordinate (in similar or contrasting colors or in any other preferably aesthetically-pleasing design combination) with that or those of the tag 16.

Preferably, a variety of kits 10 are offered via any of numerous sales outlets, including garage sales, flea markets, Internet, fairs, festivals, trade shows, all stores selling stuffed animals, boutiques, pharmacies, grocery stores. The variety of kits 10 can be offered through the same sales outlets that offer stuffed animals such as those sold under the names WEBKINZ® and SHINING STARS®. These sales outlets may include toy stores, pharmacies, grocery stores or any other retail place selling stuffed animals.

The kits 10 may be produced as follows. First, the collar 12 is created by using any of the above mentioned materials. If the selected material needs to be put together, it can be done by using any appropriate type of glue, fabric bonding, sewing, or other suitable attachment means.

Next, the fastener 14 is attached to the collar 12 for allowing fastening and unfastening of the collar 12. Next, the tag 16 can be painted or stamped. Additionally or alternatively, one or more stickers may be placed on the tag 16. Preferably, a brand or other trademark, such as “IDEEZ”, may be placed on the tag 16 for brand name recognition as described previously. When the tag 16 is ready, it may be attached to the collar 12 by using a split ring, ribbon, gimp, raffia, rope, cording, lace, elastic and/or hook and loop fastener. Brad metal tags have built in clasps. The ribbon, gimp, rope, cording, lace, raffia or elastic may be tied in a bow or knot.

Decoration, such as ribbons 32 shown in FIG. 3, or rhinestones, gems, charms, beading or jewels, shown generally at 42 in FIG. 4, may also be added to the collar 12. Such decorations may be attached to the collar 12 by various ways of attachment like sewing, gluing or sticking. Such decorations may also be added to the tag 16. For example, a ribbon 36 tied in a bow can be tied to the ring 26 attaching the tag 16 to the collar 12.

The finished collar 12 may then be placed in packaging 22 along with the labeling device 18. The labeling device can be a marker, crayon, pen, pencil, paint, paintbrush, stickers, adhesive lettering, glitter glue, glue stick or other suitable instrument that the user can use to personalize and customize the tag 16. If the tag 16 is made of wood, the labeling device 18 could be rubber stamping.

Preferably, a wide variety of combinations are offered for sale, and each kit 10 can be unique. For example, the colors of the collar 12 and tag 16 can differ as well as the materials used to construct the collar 12. The shapes and sizes of the tags 16 may vary as described above. In addition, some may have bows and some may not. The colors of the writing devices 18 in the packaging 22 can be different to appeal to a wide variety of purchasers. Preferably, different sized collars 12 are offered to accommodate different stuffed animal pet sizes, and/or adjustable collars 12 may be offered. The packaging 22 may indicate small, medium and large sizes for virtual pets, however not all will need to be a specific size.

The kit 10 can also be considered a craft kit since the user will have the opportunity to create a tag 16 themselves with all necessary tools included.

In a preferred method of using the kit 10, a user has or acquires a toy pet 20 to be personalized, and selects one or more kits 10 for purchase to use with the toy pet 20. As used throughout this application, the phrase “toy pet” refers generally to any toy having an animal-like appearance, including, but not limited to, dogs, cats, bears, lions, tigers, monkeys, birds, rabbits, ducks, cows, horses, elephants, fish, gorillas, hippopotamuses, kangaroos, koalas, lizards, frogs, skunks, snakes, turtles, alligators, crocodiles, dinosaurs and humans, such as in dolls and action figures, as well as imaginary creatures such as dragons and unicorns. The toy animal 20 can be stuffed or of other construction, such as a plastic action figure. The user removes the elements of the kit 10 from the packaging 22 and begins use as follows. Using the enclosed labeling device 18, the user can apply a personalized identifier to the tag 16.

For example, the personalized identifier can be a name 46 of the user's toy pet 20 and/or an alphanumeric code 56, as shown in FIG. 2. The term “alphanumeric” as used throughout this application refers generally to any collection of one or more letters, numbers and/or other characters. The code 56 can be the Internet identification code for a WEBKINZ® stuffed animal or another Internet-coordinated toy animal. The code 56 can be written on the tag 16a to prevent the code 56 from being lost, and allow the user to easily access the code 56 whenever needed. The personalized identifier can also include symbols, graphics, artwork and/or decorative elements.

Alternatively, some of the production steps described previously may be made part of the kit 10 for the user to complete. For example, components of the collar 12 such as collar material, tag 16, paint for the tag, bow, and fastener 14, may be provided unassembled in the packaging 22 for the user to complete the assembly himself.

The kit 10 can also include instructions informing the user on how to use the kit 10 in accordance with the method of use described above. The term “instructions” as used throughout this application, refers generally to any and all forms of printed matter, including, but not limited to, one or more sheets, leaflets, pamphlets, manuals, brochures, and/or booklets having text, graphics, photos, diagrams and/or drawings referring or relating to the method of using the kit 10 described above. Such “instructions” can be printed on a document contained inside of the packaging 22, on the packaging 22 and/or on the collar 12. In addition, the term “instructions” can include references to an Internet website address, company mailing address and/or other remote source having text, graphics, photos, diagrams and/or drawings referring or relating to the method of using the kit 10 described above. For example, in one embodiment of the invention, the packaging 22 may have an Internet website address printed thereon along with directions to the user to visit the Internet website to access instructions on using the kit 10.

A personalized identification tag collar kit for a toy pet and methods for making and using same are described above. Various details of the invention may be changed without departing from its scope. For example, while embodiments of the invention are described above as comprising an identification tag collar kit for use with a toy pet, the invention is not so limited and can be used with items other than toys, such as backpacks, gift bags, souvenirs, and wine glasses and bottles. The foregoing description of the invention and the best mode for practicing the invention are provided for the purpose of illustration only and not for the purpose of limitation—the invention being defined by the following claims and equivalents thereof.

What is claimed is:

1. An identification tag collar kit comprising:
(a) a collar;
(b) a tag for being attached to the collar; and
(c) a labeling device for applying at least one personalized identifier on the tag.

2. An identification tag collar kit according to claim 1, further comprising a package, wherein the collar, the tag and the labeling device are contained within the package.

3. An identification tag collar kit according to claim 2, wherein the package comprises transparent plastic, and includes a re-sealable opening.

4. An identification tag collar kit according to claim 2, further comprising at least one selected from the group consisting of a label attached to the package having a brand name printed thereon, and an insert enclosed in the package having a brand name printed thereon.

5. An identification tag collar kit according to claim 2, wherein the tag is attached to the collar.

6. An identification tag collar kit according to claim 1, wherein the collar includes a fastening device for fastening and releasing the collar.

7. An identification tag collar kit according to claim 1, wherein a length of the collar is adjustable.

8. An identification tag collar kit according to claim 1, wherein the tag includes an aperture, and further comprising a ring positioned through the aperture and around the collar for attaching the tag to the collar.

9. An identification tag collar kit according to claim 1, wherein the labeling device comprises one or more selected from the group consisting of a pen, marker, pencil, crayon, sticker, stamp, and paint.

10. An identification tag collar kit according to claim 1, further comprising instructions instructing a user to apply at least one personalized identifier on the tag using the labeling device.

11. An identification tag collar kit according to claim 10, further comprising packaging containing the collar, the tag, the labeling device and the instructions.

12. An identification tag collar kit according to claim 1, wherein the kit is adapted for use with a toy pet, and the collar is adapted for being worn on the toy pet.

13. An identification tag collar kit according to claim 12, wherein the personalized identifier comprises one or more selected from the group consisting of a name for the toy pet, a name of the user, an alphanumeric code, and the user's decorative artwork.

14. An identification tag collar kit according to claim 12, wherein the labeling device comprises a writing instrument selected from the group consisting of a pen, marker, pencil, and crayon, and further comprising instructions instructing a user to write an alphanumeric identification code provided by a seller of the toy pet for using on an Internet website relating to the toy pet.

15. An identification tag collar kit for use with a toy pet comprising:
(a) a collar adapted for being worn on a toy pet, the toy pet having an alphanumeric identification code for use on an Internet website relating to the toy pet;
(b) a tag attached to the collar;
(c) a writing instrument;
(d) a package, wherein the collar, the tag, and the writing instrument are contained within the package; and
(d) instructions instructing a user to use the writing instrument to write the identification code of the toy pet on the tag.

16. A method of using an identification tag collar kit comprising the steps of:
(a) providing a toy pet;
(b) providing an identification tag collar kit comprising a collar, a tag attached to the collar, a labeling device and a package containing the collar, the tag and the labeling device;
(c) removing the collar, the tag and the labeling device from the package;
(d) using the labeling device to apply a personalized identifier to the tag; and
(e) positioning the collar on the toy pet.

17. A method according to claim 16, wherein the step of providing a toy pet comprises providing a stuffed animal having an alphanumeric identification code for use on an Internet website relating to the toy pet, and further wherein the personalized identifier comprises the identification code.

18. A method according to claim 16, wherein the toy pet has an alphanumeric identification code for use on an Internet website relating to the toy pet.

19. A method according to claim 18, wherein the labeling device comprises a writing instrument, and the step of using the labeling device to apply a personalized identifier to the tag comprises writing the identification code of the toy pet on the tag.

20. A method according to claim 19, wherein the step of using the labeling device to apply a personalized identifier to the tag further comprises writing a name for the toy pet on the tag.
